(19) United States
(12) Patent Application Publication
(10) Pub. No.: US 2005/0077420 A1
(43) Pub. Date: Apr. 14, 2005

(54) Hygienic paper dispenser

(76) Inventor: Werner Kaufmann, Buchs (CH)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/497,412

(22) PCT Filed: Nov. 19, 2002
(86) PCT No.: PCT/CH02/00620

(30) Foreign Application Priority Data
Dec. 7, 2001 (CH) 2244/01

(51) Int. Cl. B05C 1/00; B65H 19/29

(52) U.S. Cl. 242/580; 118/207; 118/231

(57) ABSTRACT

A dispenser for hygiene paper is proposed which makes available dry toilet paper and dispenses moistened hygiene paper. For this purpose, the dispenser contains a housing, a roll holder for the hygiene paper, a unit for the moistening with a liquid container, a moistening roll and at least one liquid tank which communicate with one another and a unit for the dispensing with a transport roll for the hygiene paper which is in contact with the moistening roll with an intermediate layer of the hygiene paper. The dispenser can be divided into a base housing and an insertion part. The advantage of the dispenser consists of commercially available toilet paper being made available and of moistened hygiene paper being dispensed in a specific length or in any desired length and of the dispenser being made simply and being easy to handle.

The invention relates to a dispenser for hygiene paper containing a housing, a first roll holder for the reception of a roll with a hygiene paper, a unit for the moistening of the hygiene paper with a liquid container, with a moistening roll and with a liquid tank which communicates with the liquid container (21) and the moistening roll and a guide roll for the hygiene paper.

Dry toilet paper and moist cleaning tissues are used for hygiene. In use, it has been found to be disadvantageous that the toilet paper and the cleaning tissues are presented spatially separately and the moist cleaning tissues can dry out. This can be very unpleasant in certain situations.

In DE A 26 44 871, a toilet tank is described from which dry and moistened toilet paper can be taken from a dispensing roll. The tank substantially consists of a housing in which a roll holder for the toilet paper is arranged and a flask which is arranged outside the housing. A deflection roll for the toilet paper, a transport roll for the toilet paper standing under spring action, a liquid container which communicates with the flask and a moistening roll which is connected to the liquid container line-wise are arranged in the tank. The toilet paper is guided over the deflection roll and the transport roll and is held by these at a member with a tear-off edge. Dry toilet paper can be pulled off in this position. To moisten the toilet paper, the toilet paper is brought—against the spring action—into contact with the roll standing in line-wise connection with the liquid container.

The disadvantages of the tank can be seen in the fact that the toilet paper is moistened by pulling the toilet paper against the spring action, with the degree of moistening depending on the pull-off speed. Toilet paper can thereby be moistened only partly or too strongly. With too high a pulling force, the moistened toilet paper can be torn or the dry toilet paper can be torn off outside the perforation and is consequently unusable. The tank is not suitable for the use of non-perforated hygiene paper from the roll. The reason for this can be seen in the relatively high tear strength of the hygiene paper.

It is the underlying object of the invention to provide a dispenser for hygiene paper which does not have the aforesaid disadvantages.

The object is satisfied in accordance with the invention by the features of the independent claim. Further developments of the invention result from the dependent claims.

It is the underlying idea of the invention to make available by means of a dispenser dry hygiene paper or to present moistened hygiene paper, which can be used as toilet paper or as a cleaning tissue after the tearing off. There are provided for this purpose, roll holders for the respective hygiene paper arranged at a housing, a unit for the moistening of the hygiene paper with a liquid tank, a liquid container and a moistening roll, which communicate with one another, a unit for the dispensing with a transport roll for the transport of the hygiene paper, the transport roll being in contact with the moistening roll through the intermediary of a layer of the hygiene paper, with a drive unit for the transport roll and a control unit.

The advantages which can be achieved with the invention can substantially be seen in the fact that commercially available dry toilet paper is made available and moistened hygiene paper is dispensed usable as cleaning tissues and in that the dispenser is simply made and is simple to handle.

It is of advantage for the housing to consist of a base housing and an insertion part which are connected via plug connections, for three liquid tanks to be arranged at the base housing and for the insertion part to include the liquid container. The servicing and in particular the cleaning of the dispenser is thereby facilitated.

A hood with a means for the separation of the hygiene paper can be provided for the covering of the roll with the hygiene paper and of the liquid container. The wet portion of the dispenser is thus covered and the possibility is provided of using both perforated and non-perforated hygiene paper.

If the guide roll and the transport roll are rotatably arranged in the hood, the hygiene paper can easily be inserted in an advantageous manner when the hood is pivoted downwardly.

The invention will be explained with reference to the enclosed drawings in the following.

There are shown:

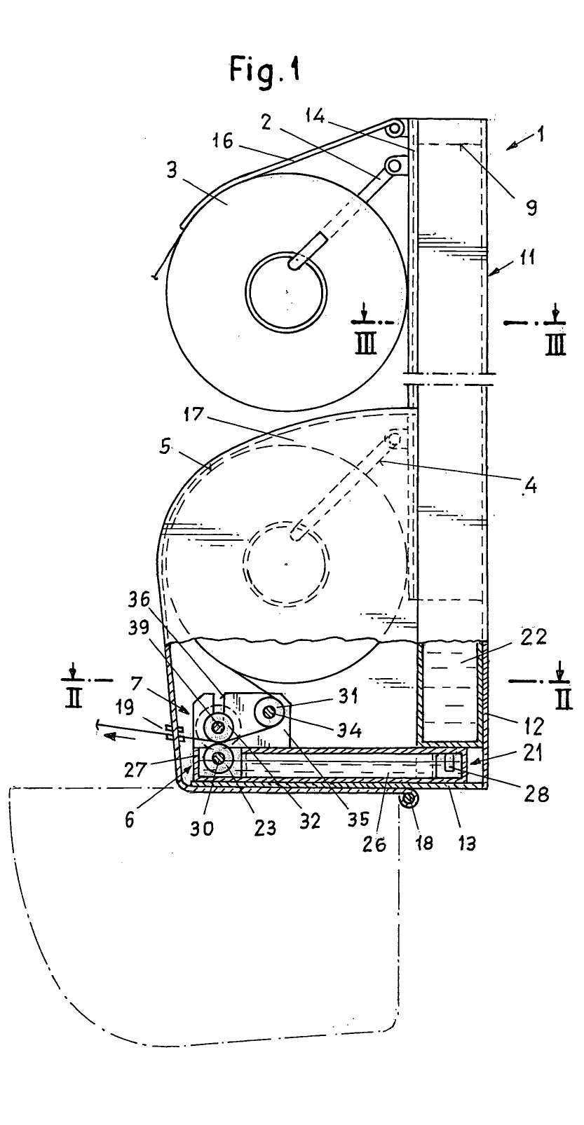

FIG. 1 a partly openly illustrated side view of a first embodiment of a dispenser in accordance with the invention;

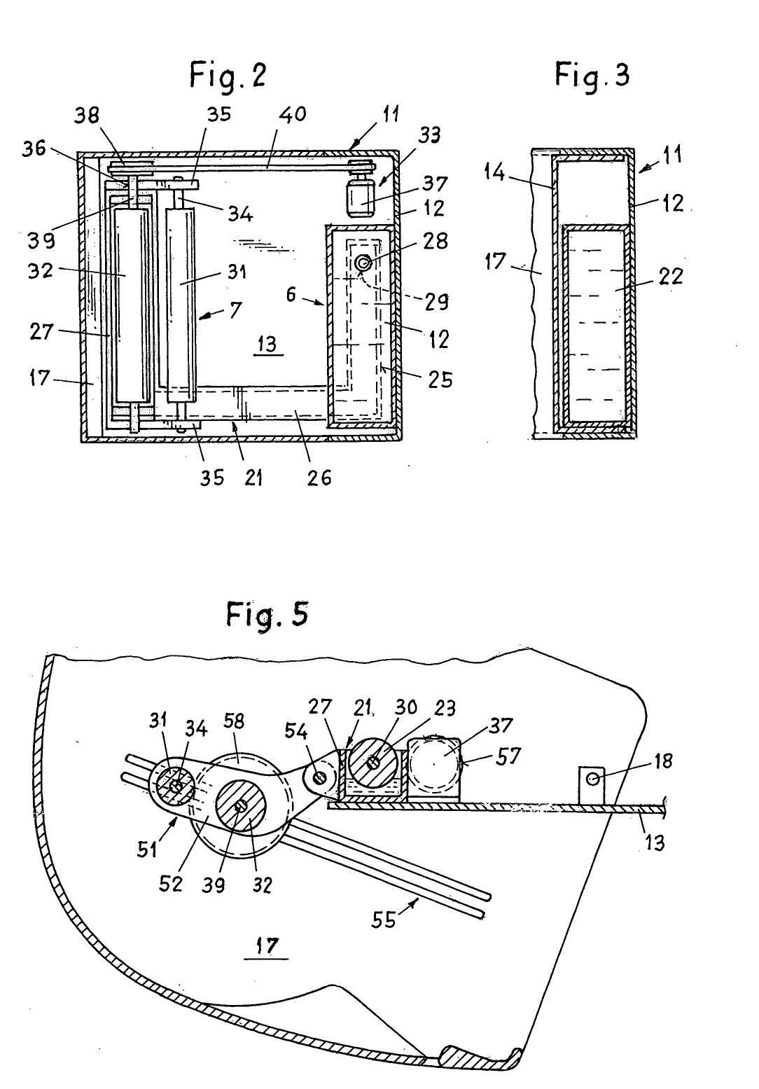

FIG. 2 a section along the line II-II in FIG. 1;

FIG. 3 a section along the line III-III in FIG. 1;

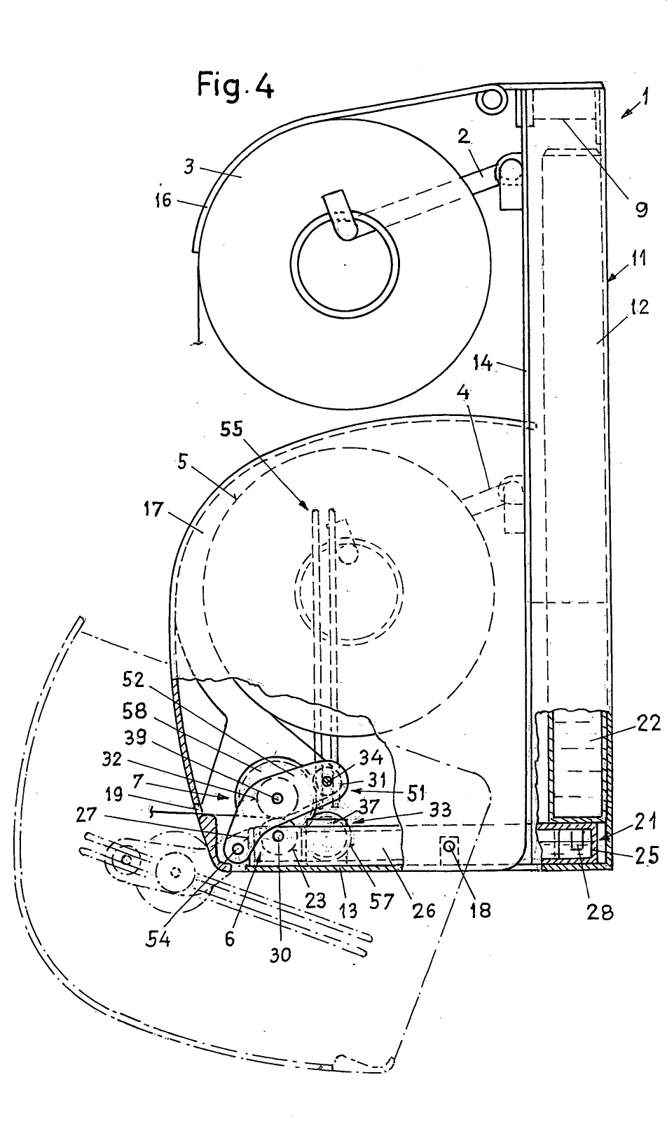

FIG. 4 a partly openly illustrated side view of a second embodiment of a dispenser in accordance with the invention;

FIG. 5 a view of the transport unit in an unfolded position;

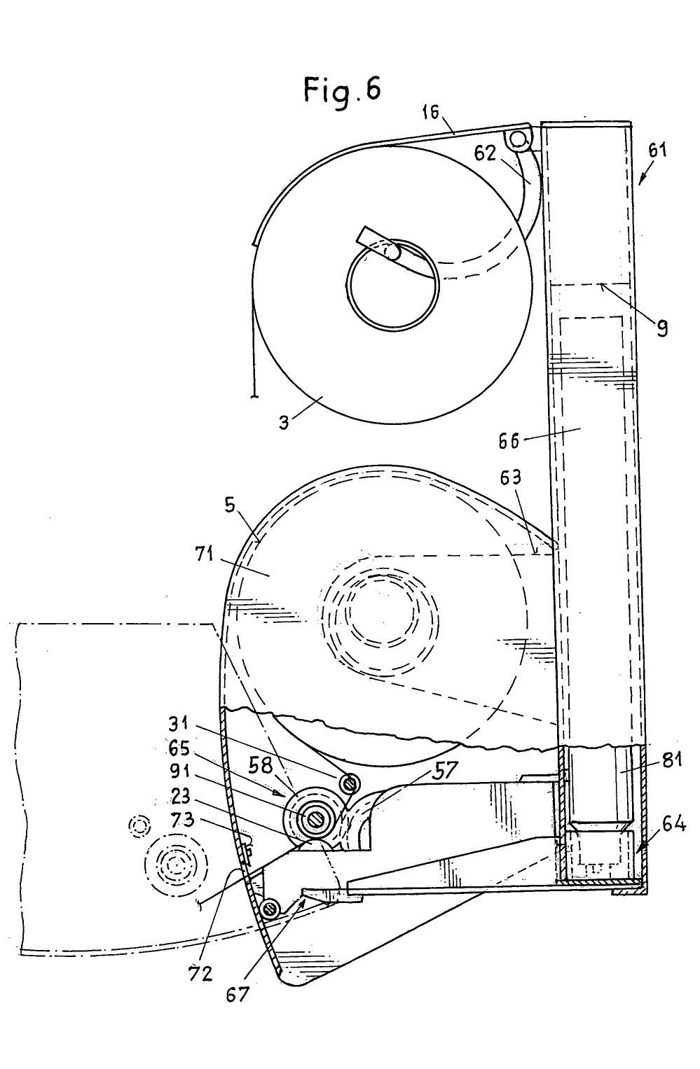

FIG. 6 a partly openly illustrated side view of a third embodiment of a dispenser in accordance with the invention;

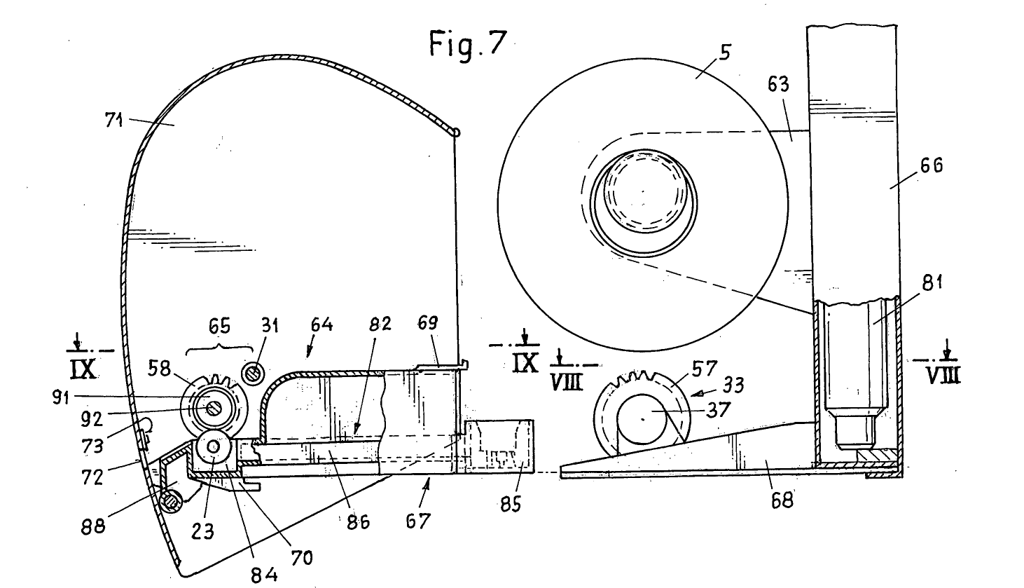

FIG. 7 a side view of the dispenser in the separated state;

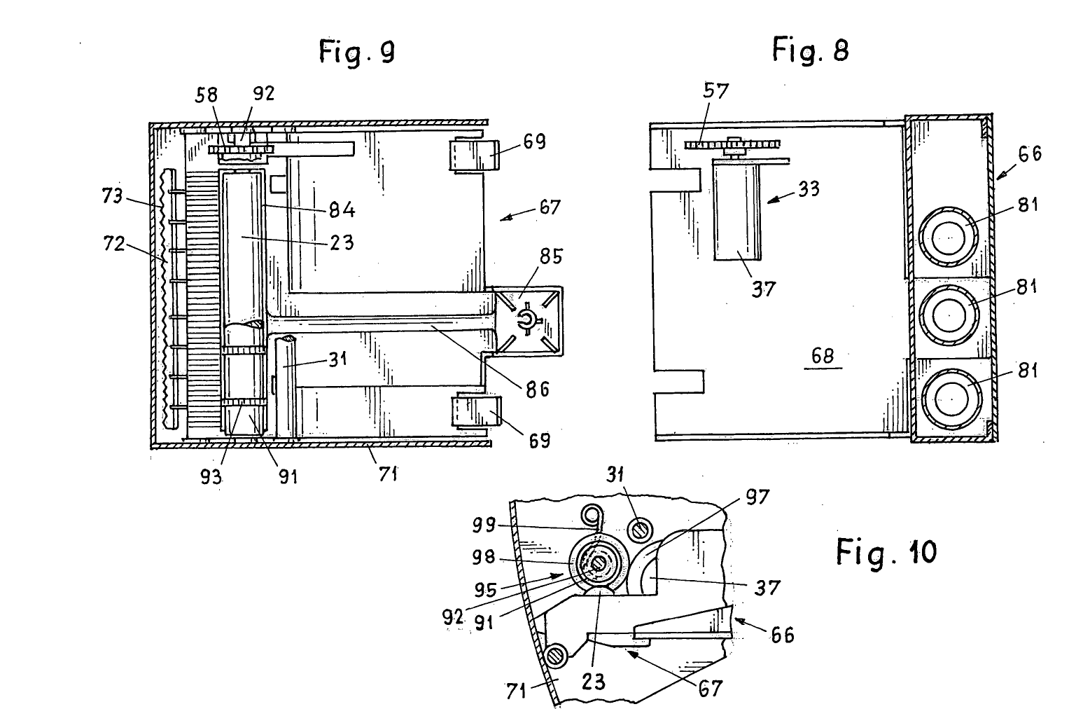

FIG. 8 a section along the line VIII-VIII in FIG. 7;

FIG. 9 a section along the line IX-IX in FIG. 7; and

FIG. 10 a modification of the drive unit.

Reference is made to FIGS. 1 to 3. The dispenser contains a housing 1, a first roll holder 2 for the mounting of a dispensing roll 3 with toilet paper, a second roll holder 4 for the mounting of a dispensing roll 5 with paper to be moistened, a unit 6 for the moistening, a unit for the dispensing 7 of cleaning tissues and a control unit 9.

The housing 1 contains a U-shaped holder 11 consisting of a base section 12 for the fastening of the dispenser to a wall or the like and a wall section 13 projecting therefrom at right angles as well as a U-shaped support part 14 for the roll holders 2 and 4 which is arranged in the holder 11 and is releasably or fixedly connected thereto. The roll holders 2 and 4 are fastened to the base section of the support part 14. The housing 1 furthermore contains a pivotable flap 16, which is associated with the first roll holder 2, and a hood 17 to cover the wet part of the dispenser and is arranged pivotably about the axis 18. A slot 19 is provided in the hood 17 for the dispensing of the cleaning tissues.

The housing 1, the flap 16 and the hood 17 advantageously consist of plastic or of metal. Combinations of these materials can also be used.

The unit 6 for the moistening includes a liquid container 21, a liquid tank 22 and a moistening roll 23. The liquid container 21 is made in U shape such that the one limb 25 and the base section 26 are made as a tube and the other limb 27 is made as a trough. The liquid container 21 is arranged on the wall section 13 such that the one limb 23 lies beneath the liquid tank 22. The liquid tank 22 has a stub 28 which can be inserted into an aperture 29 provided in the limb 25 while simultaneously opening the liquid container. The moistening roll 23 is arranged in the limb 27 formed as a trough freely rotatably about the axis 30.

The unit 7 for the dispensing includes a guide roll 31, a transport roll 32 and a drive unit 33 for the transport roll 32. The guide roll 31 and the transport roll 32 are arranged in support members 35 rotatably about the axes 34 and 39, with the transport roll 32 lying on the moistening roll 23. A respective slot 36 is provided in the support members 35 for the insertion and raising of the transport roll 32. The drive unit 33 includes a stepping motor 37 having a belt pulley which is connected to the control unit 9, a belt pulley 38 fastened to the axle 39 of the transport roll 32 and a belt 40.

The control unit 9 is arranged in the housing 1 and includes a conventional electronic control which is charged by a battery and is activated by a switch.

Reference is made to the FIGS. 4 and 5. These Figures show a second embodiment of the dispenser and essentially differ from the first embodiment in the design of the unit for the dispensing. Only the differences are therefore described in the following description.

The unit 30 for the dispensing includes a guide roll 31, a transport roll 32 and a drive unit 33 for the transport roll 32. The guide roll 31 and the transport roll 32 are arranged on a holder 51. The holder 51 consists of two levers 52 and two axles 34 and 39 on which the guide roll 31 and the transport roll 32 are rotatably arranged, with the transport roll 32 lying on the moistening roll 23. The axles 32 and 39 are releasably mounted on the levers 52. It can be seen from FIG. 2 that the holder 51 is pivotably arranged about an axis 54 at the liquid container 21. Furthermore, a guide 55 is provided for the pivoting of the holder 51 on the hood 17 and is in active connection with the axle 34 of the guide roll 31.

The drive unit 33 includes a stepping motor 37 which is connected to the control unit 9, a first toothed wheel 57 which is fastened to the axle of the stepping motor 37 and a second toothed wheel 58 which is fastened to the axle 39 of the transport roll 32.

In a modified embodiment (not shown) of the previously described dispenser, the guide 55 is omitted such that the holder 51 can be manually adjusted when the hood 17 is open. Instead of the guide, a member is provided which holds the toothed wheels 57 and 58 in engagement when the hood 17 is closed.

Reference is made to the FIGS. 6 to 9. The dispenser contains a housing 61, a first roll holder 62 for the mounting of a dispensing roll 3 with toilet paper, a second roll holder 63 for the mounting of a dispensing roll 5 with hygiene paper to be moistened, a unit 64 for the moistening, a unit for the dispensing 65 and a control unit 9.

With respect to the embodiments described above, the housing 61 contains a base housing 66 for fastening to a wall or the like and an insertion part 67 which is releasably connected to the base housing 66. The base housing 66 consists of a rectangular box which is closed at the lower narrow side and is provided at the upper narrow side with closable apertures and of a support part 68 which projects at right angles and is fastened to the lower narrow side of the base housing 66. The roll holders 62, 63 are mounted to the base housing 66. The base housing 66 furthermore contains a pivotable flap 16. The insertion part 67 has latching jacks 69 which can be inserted into openings in the base housing 66 and support sections 70 into which the support part 68 can be inserted—the whole such that the insertion part 67 is removably arranged.

A hood 71 is pivotably arranged at a nose 88 which is formed at the insertion part 67. The hood 71 has an opening 72 for the dispensing of the moistened hygiene paper. A tear-off blade 73 is arranged in the region of the opening 72 at the hood wall or at the nose 88 of the insertion part 67 for the tearing off of moistened hygiene paper. A tear-off edge can be formed at the opening 72 instead of the tear-off blade.

With respect to the embodiments described above, the unit 64 for the moistening contains three liquid tanks 81, a liquid container 82 which is integrated into the insertion part 67 and a moistening roll 23. The liquid container 82 has a trough-shaped recess 84 for the mounting of the moistening roll 23, a connection section 85 for the connection of a liquid tank 81 and a channel-shaped recess 86 for the connection of the trough-shaped recess 84 to the connection section 86. The moistening roll 23 is arranged freely rotatably in the trough-shaped recess 84.

The unit 65 for the dispensing includes a guide roll 31, a transport roll 91 and a drive unit 33. With respect to the embodiments described above, the guide roll 31 and the transport roll 91 are arranged in the hood 71 and the drive unit 33 at the base housing 66 and also in the hood 71. The drive unit 33 includes a stepping motor 37 which is fastened to the support part 68 of the base housing 66, a first toothed wheel 57 which is fastened to the motor axle and a second toothed wheel 58 which is fastened to the axle 92 of the transport roll 91. The transport roll 91 has ring-shaped projections 93 at the periphery which are provided with ribbing to ensure the transport of the moistened hygiene paper.

The control unit 9 is arranged in the base housing 66 and contains an electronic circuit which is charged by a battery or from the mains network and is activated by a switch. The control unit 9 is advantageously designed such that, when the switch is actuated, a specific length of moistened hygiene paper is dispensed or, when the switch is actuated, any desired length of moistened hygiene paper is dispensed.

Reference is made to FIG. 10. Instead of the previously described embodiments, a modified drive unit can be provided which has a first friction wheel (97) connected to the stepping motor (37), a second friction wheel (98) connected to the transport roll (32; 91) and a spring element (99) to press the second friction wheel toward the first friction wheel. The transport roll is supported in an elongate hole for this purpose.

1. A dispenser for hygiene paper, containing a housing (1; 61), a roll holder (2; 62) for the mounting of a roll (3; 61) with a hygiene paper, a unit (6; 64) for the moistening of the hygiene paper with a liquid container (21; 82), with a moistening roll (23) and a liquid tank (22; 81) which communicates with the liquid container (21; 82) and the moistening roll (23) and a guide roll (31) for the hygiene paper, characterized by a second roll holder (4; 63) for the mounting of a roll (5) with a second hygiene paper which is arranged beneath the first roll holder (2; 62), by a unit (7; 65) for the dispensing with a transport roll (32; 91) for the transporting of the hygiene paper, the transport roll being in contact with the moistening roll (23) through the intermediary of a layer of the hygiene paper, by a drive unit (33) for the transport roll (32; 91) and by a control unit (9) for the drive unit (33).

2. A dispenser in accordance with claim 1, characterized in that a hood (17) is provided for the covering of the roll (5) with the second hygiene paper and of the guide roll (31) and of the transport roll (32).

3. A dispenser in accordance with claim 2, characterized in that the hood (17) is pivotably supported at the housing (1).

4. A dispenser in accordance with claim 1, characterized in that the moistening roll (23) is arranged freely rotatably and removably in the liquid container (21).

5. A dispenser in accordance with claim 1, characterized by support members (35) for the guide roll (31) and the transport roll (32).

6. A dispenser in accordance with claim 1, characterized in that the drive unit (33) contains a stepping motor (37) which is fastened to the housing (1).

7. A dispenser in accordance with claim 6, characterized in that a belt drive is associated with the stepping motor (7) and is connected to the moistening roll (23).

8. A dispenser in accordance with claim 1 or claim 2, characterized in that the housing (1) consists of plastic and/or of metal.

9. A dispenser in accordance with claim 1, characterized in that the guide roll (31) and the transport roll (32) are freely rotatably supported on a holder (51) and in that the holder (51) is pivotably arranged at the housing (1).

10. A dispenser in accordance with claim 3 and claim 9, characterized in that the hood (17) has means (55) for the pivoting of the hood (17) and of the holder (51) in the same direction.

11. A dispenser in accordance with claim 6, characterized in that a toothed drive is associated with the stepping motor (37) and is connected to the transport roll (32; 91).

12. A dispenser in accordance with claim 1, characterized in that the housing (61) consists of a base housing (66) and an insertion part (67) which are releasably connected via means (69, 70).

13. A dispenser in accordance with claim 1, characterized in that a hood (71) is provided for the covering of the roll (5) with the second hygiene paper and of the insertion part (67) and in that a means (73) for the separation of the second hygiene paper is arranged at the hood (71) or at the nose (88) of the insertion part (67).

14. A dispenser in accordance with claim 13, characterized in that the hood (71) is pivotably arranged at the insertion part (67) and in that the guide roll (31) and the transport roll (91) are rotatably supported in the hood (71).

15. A dispenser in accordance with claim 12, characterized in that three liquid tanks (81) are arranged in the base housing (66) and in that the liquid container (82) is made from a trough-shaped recess (84) for the mounting of the moistening roll (23), a connection section (85) for the connection of a liquid tank (81) and a channel-shaped recess (86) for the connection of the trough-shaped recess (84) to the connection section (85).

16. A dispenser in accordance with claim 1, characterized in that the transport roll (91) has ring-shaped projections (93) at the periphery which are provided with ribbing.

17. A dispenser in accordance with claim 6, characterized in that a friction wheel drive (95) is associated with the stepping motor (37).
